(19) United States
(12) Patent Application Publication
(10) Pub. No.: US 2024/0110093 A1
(43) Pub. Date: Apr. 4, 2024

(54) SYNERGISTIC SYSTEMS FOR BREAKING POLYMER VISCOSIFIED FLUIDS

(71) Applicant: Finoric, LLC, Beasley, TX (US)

(72) Inventors: Marek Pakulski, The Woodlands, TX (US); Deepak Patil, Friendswood, TX (US); Ambrish Kamdar, Beasley, TX (US)

(73) Assignee: Finoric, LLC, Beasley, TX (US)

(21) Appl. No.: 17/958,750

(22) Filed: Oct. 3, 2022

(51) Int. Cl. C09K 8/66; C09K 8/68

(52) U.S. Cl. CPC C09K 8/665; C09K 8/68; C09K 2208/26

(57) ABSTRACT

A synergistic fluid solution for breaking gelled fracturing fluid comprises an oxidizer, a transition metal, and an alkali compound at a total composition of between 100 and 150,000 ppm, wherein the gelled fracturing fluid is capable of significantly reducing viscosity of a gelled fracturing fluid within a time period between 30 minutes and 240 minutes after introduction at a temperature between 100° F. and 300° F.

### REFERENCE TO RELATED APPLICATIONS

This is a US Utility Patent application claiming priority and benefit from U.S. Provisional Application No. 63/251,339, filed 1 Oct. 2021 and having the same inventors and title. The contents of the above provisional application are fully incorporated by reference.

### FIELD

The present invention relates to a breaker composition including an effective concentration of an oxidizer, an alkaline compound, and a transition metal, adapted to break the viscosity of a viscosified fluid to a desired (lower) value at downhole conditions within a time period coincident with a formation stimulation time and to methods for making and using same.

### BACKGROUND

One of the key problems in the use of slick water, linear gels and crosslinked fluids for stimulation and fracturing applications is to find a composition and/or method that controllably breaks such polymer viscosified systems at bottom hole conditions. The ideal breakers are those that can be delivered under controlled or controllable conditions sufficient to reduce a downhole fluid viscosity to a desired low value during a formation stimulation, i.e., for a time not shorter than and not much longer than a time needed to complete the formation stimulation.

There are many effective oxidative breakers, acid breakers, terpene breakers and enzyme breakers, or combinations thereof, formulated either as a pure material, a solution, a suspension or an encapsulation that break the fluid in shorter or longer periods of time than needed to complete the formation stimulation. These breakers are only effective in narrow ranges of temperatures, which are not necessarily identical to or similar to bottom hole conditions. These systems have been introduced and widely used by all services companies.

U.S. Pat. No. 5,413,178 discloses a composition and method for breaking polymer viscosified fluids using an alkali metal chlorite or hypochlorite, which releases oxygen chloride in a controllable manner to break down the polymer structure, and, therefore, decrease the viscosity of the polymer viscosified fluids.

U.S. Pat. No. 7,712,535 discloses a composition and method for breaking polymer viscosified fluids using an alkali metal chlorite and/or hypochlorite, which releases oxygen chloride in a controllable manner in combination with a transition metal chloride is selected from the group consisting of cuprous chloride, cupric chloride, ferrous chloride, ferric chloride, cobalt chlorides, manganese chlorides, chromium chlorides, to break down the polymer structure, and, therefore, decrease the viscosity of the polymer viscosified fluids.

U.S. Pat. No. 5,624,886 discloses using an insoluble oxidant which can also contain a chelating agent and an activator to break the gels. The activator is preferably selected from the group consisting of iron and copper complexes of ethylenediaminetetraacetic acid.

U.S. Pat. No. 9,796,900 discloses using an oxidant and sodium hydroxide as an activator to break the gels.

Although there are breakers known to decrease the viscosity of downhole fluids during stimulation and/or fracturing operations, there is still a need in the art for breaker systems and methods of use that can effectively lower the viscosity of a downhole fluid to desired low value under downhole conditions. Embodiments of the invention disclosed in

### SUMMARY OF THE INVENTION

The present invention provides a synergistic breaker composition, including an effective concentration of an oxidizer, to reduce a viscosity of a polymer viscosified fluid to a desired low value at downhole conditions within a time period coincident with a formation stimulation time and to methods for making and using same.

The present invention also provides the use of a fluid composition including an effective concentration of an oxidizer to reduce a viscosity of a polymer viscosified fluid to a desired low value at downhole conditions within a time period coincident with a formation stimulation time, generally between about 30 minutes and 240 minutes.

The present invention provides a polymer fluid breaking composition including an effective concentration of an oxidizer, including but not limited to chlorites, chlorates, bromates, peroxides, persulfates, perborates, and a transition metal and an alkaline compound where the amount is sufficient to reduce a viscosity of a polymer viscosified fluid to a desired low value at downhole conditions within a time period coincident with a formation stimulation time, generally between about 30 minutes and 240 minutes.

The present invention also provides the use of a fluid composition including an effective concentration of an oxidizer and a transition metal including but not limited to copper, iron, zinc, nickel, titanium, manganese, cobalt and vanadium, to reduce a viscosity of a polymer viscosified fluid to a desired low value at downhole conditions within a time period coincident with a formation stimulation time, generally between about 30 minutes and 240 minutes.

The present invention also provides the use of a fluid composition including an effective concentration of an oxidizer and a transition metal and an inorganic alkaline compound including but not limited to hydroxides, carbonates and bicarbonates of ammonia, sodium, potassium, magnesium, lithium, and/or an organic alkaline compound including but not limited to amines, amino alcohols, hydroxylamines to reduce a viscosity of a polymer viscosified fluid to a desired low value at downhole conditions within a time period coincident with a formation stimulation time, generally between about 30 minutes and 240 minutes.

The present invention also provides the use of a fluid composition including an effective concentration of ammonium persulfate and an organic base such as triethanolamine, and a transition metal compound such as cupric chloride to reduce a viscosity of a polymer viscosified fluid to a desired low value at downhole conditions within a time period coincident with a formation stimulation time, generally between about 30 minutes and 240 minutes.

The present invention provides a method for breaking a viscosity of a viscosified fluid during formation stimulation including the step of injecting a fluid composition of this invention into a viscosified fluid downhole to reduce a viscosity of the polymer viscosified fluid to a desired low value at downhole conditions within a time period coincident with a formation stimulation time, generally between about 30 minutes and 240 minutes.

### BRIEF DESCRIPTION OF THE DRAWINGS

The invention can be better understood with reference to the following detailed description together with the appended illustrative figures:

FIGS. 1, 2, and 3 present the tabulated data from Tables 1, 2 and 3, respectively, in graphical form, to present the effect of using synergistic breaker ammonium persulfate with cupric chloride and triethanolamine in breaking the dynamic fracturing systems of Examples 1 and 2 at temperatures between 100° F. and 300° F.

### DETAILED DESCRIPTION OF THE INVENTION

The inventors have found that a fluid breaker for use with slick water, linear gels, or crosslinked gels can be prepared from an oxidizer alone or in combination with a transition metal chloride and an alkaline compound, depending on the type of viscosified fluid to which the liquid breaker is being applied. The inventors have also found that the liquid breaker composition can be injected into a polymer viscosified well fluid in an amount sufficient to reduce a viscosity of the polymer viscosified fluid to a desired low value at downhole conditions within a time period coincident with a formation stimulation time, generally between about 30 minutes and 240 minutes.

A general description of fracturing fluid composition, including various examples of polymers, cross-linking agents, surfactants, acids, and salts can be found in US 2005/0003965.

A general description of fracturing fluid treatment methods and procedures, including the alternating fluid stages, proppant materials, gelling, breaking, and the use of additives can be found in U.S. Pat. No. 7,566,656.

In an embodiment, the present invention broadly relates to an aqueous fluid including an effective concentration of a synergistic composition comprising an oxidizer, such as ammonium persulfate, a transition metal to act as an cation donor, such as cupric chloride, and an alkali compound, such as triethanolamine, where the amount is sufficient to break down or reduce the viscosity of a gelled fracturing systems within a time period between 30 minutes and 240 minutes after introduction at a temperature between 100° F. and 300° F.

The effective concentration of the synergistic breaker composition is between about 100 ppm and 150,000 ppm in an aqueous solution. In terms of individual concentrations, the effective concentration of oxidizer may be between 50 ppm and 100,000 ppm, and the effective concentration of alkali may be between 50 ppm and 100,000 ppm. The effective concentration of transition metal may be between 0.1 ppm and 500 ppm. ppm (Note that although cupric chloride is used here any suitable ionic compound may be used as the purpose of the transition metal is to unbind and donate a cation.)

The treatment quantity of the synergistic breaker having the effective concentration can be adjusted based on downhole conditions to an amount between 50 ppm and 15,000 ppm, or 0.42 PPTG to 84 GPTG. In other words, when accounting for downhole fluids the treatment quantity for the ammonium persulfate may be between 50 ppm and 10,000 ppm, the treatment quantity for the triethanolamine may be between 50 ppm and 10,000 ppm, and the treatment quantity for the transition metal (cupric chloride), 0.1 ppm and 50 ppm.

The ammonium persulfate suitable for use in this invention includes, without limitation, aqueous solutions of water and ammonium persulfate, dry ammonium persulfate and/or encapsulated ammonium persulfate designed for delayed release along with an additive selected from the group consisting of an additive selected from the group consisting of a transition metal chloride, and, where the organic base include alkanolamine such as triethanolamine, mixtures or combinations thereof.

Suitable transition metal chlorides include, without limitation, cuprous or cupric chloride, ferrous or ferric chloride, cobalt chlorides, manganese chlorides, chromium chlorides, other transition metal chlorides that are stable in water and mixtures or combinations thereof. Other suitable water soluble salts can also be used instead of the chlorides to provide the same amount of transition metal.

Suitable organic and inorganic bases include, without limitation, ammonium hydroxide, ammonium carbonate, sodium hydroxide sodium carbonate, potassium hydroxide, potassium carbonate, lithium hydroxide, lithium carbonate, mono-di-tri ethanolamines, mono-di-tri alkylamines, mono-di-tri alkanolamines and other transition metal chlorides and alkaline compounds that are stable in water and mixtures or combinations thereof.

### EXAMPLES

in the following exemplar embodiments, a gelled fracturing fluid was prepared from a from a polymer and a crosslinking agent. 25 to 30 pounds of guar per 1000 gallons of water gel was prepared using commercially available 40-45 grade guar available from various suppliers and tap water. Ammonium persulfate, triethanolamine, and cupric chloride were all purchased from Sigma-Aldrich.

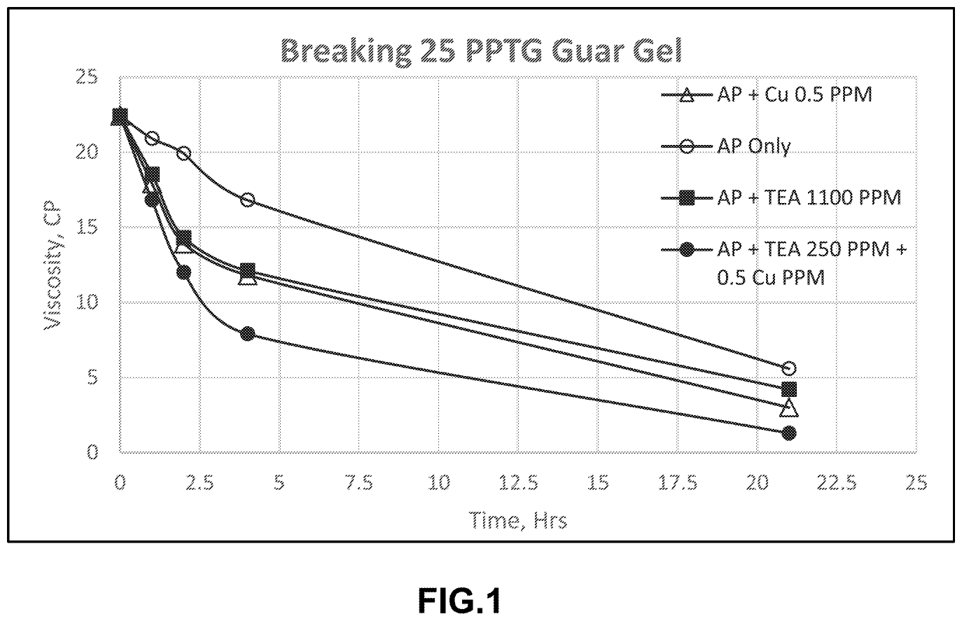

Table 1 and FIG. 1 illustrate the breaking of 25 PPTG (pounds per thousand gallons) guar gel with ammonium persulfate (AP) alone, ammonium persulfate with triethanolamine (TEA), ammonium persulfate with cupric chloride (Cu), and ammonium persulfate with both triethanolamine and cupric chloride. AP treatment quantity was constant at 1.25 PPTG, TEA dosage in combination with AP was 1100 PPM, Cu Dosage in combination with AP was 0.5 PPM, and TEA dosage was 250 PPM, and Cu dosage was 0.5 PPM in combination with AP

TABLE 1

| | Time, Hrs | | | | |
|---|---|---|---|---|---|
| | 0 | 1 | 2 | 4 | 21 |
| | Viscosity, CP | | | | |
| AP | 22.4 | 20.9 | 19.9 | 16.8 | 5.6 |
| AP + TEA 1100 PPM | 22.4 | 18.5 | 14.3 | 12.1 | 4.2 |
| AP + Cu 0.5 PPM | 22.4 | 17.9 | 13.9 | 11.8 | 3 |
| AP + TEA 250 PPM + Cu 0.5 PPM | 22.4 | 16.8 | 12 | 7.9 | 1.3 |

Table 1 illustrates the breaking of 25 PPTG guar gel with ammonium persulfate (AP) alone, ammonium persulfate with triethanolamine (TEA), ammonium persulfate with cupric chloride (Cu), and ammonium persulfate with both triethanolamine and cupric chloride. AP dosage was constant at 1.25 PPTG, TEA dosage in combination with AP was 550 PPM, Cu Dosage in combination with AP was 0.25 PPM, and TEA dosage was 250 PPM, and Cu dosage was 0.25 PPM in combination with AP.

Breaking the guar gel with AP and TEA alone required 1100 PPM of TEA. Breaking the guar gel with AP and 0.5 PPM Cu alone, but without TEA gave comparable breaking performance. However, using the synergistic breaker of this invention, i.e., adding 0.5 PPM of Cu and 250 PPM TEA, further reduced the breaking time.

TABLE 2

| | Time, Hrs | | | | |
|---|---|---|---|---|---|
| | 0 | 1 | 2 | 4 | 21 |
| | Viscosity, CP | | | | |
| AP | 22.4 | 20.9 | 19.9 | 16.8 | 5.6 |
| AP + TEA 550 PPM | 22.4 | 17.8 | 15 | 12.1 | 1.3 |
| AP + Cu 0.25 PPM | 22.4 | 17.2 | 15 | 12.2 | 1.6 |
| AP + TEA 125 PPM + Cu 0.25 PPM | 22.4 | 16 | 12.2 | 8.1 | 1.3 |

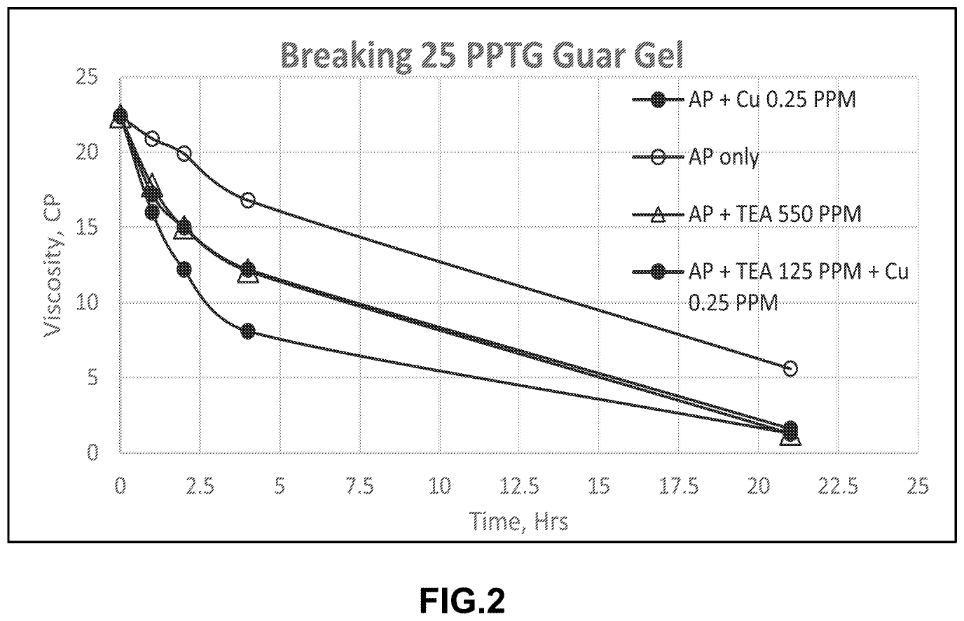

Turning now to Table 2 and FIG. 2, this example illustrates the breaking of 25 PPTG guar gel with ammonium persulfate (AP) alone, ammonium persulfate with triethanolamine (TEA), ammonium persulfate with cupric chloride (Cu), and ammonium persulfate with both triethanolamine and cupric chloride. AP dosage was constant at 1.25 PPTG, TEA dosage in combination with AP was 550 PPM, Cu Dosage in combination with AP was 0.25 PPM, and TEA dosage was 250 PPM, and Cu dosage was 0.25 PPM in combination with AP

Breaking the guar gel with AP and TEA alone required 550 PPM of TEA. Breaking the guar gel with AP and 0.25 PPM Cu alone, but without TEA, gave comparable breaking performance. However, using the synergistic breaker of this invention, i.e., adding 0.25 PPM of Cu and 125 PPM TEA, further reduced the breaking time.

TABLE 3

| | Time, Hrs | | | | |
|---|---|---|---|---|---|
| | 0 | 1 | 2 | 4 | 21 |
| | Viscosity, CP | | | | |
| AP | 22.4 | 20.9 | 19.9 | 16.8 | 5.6 |
| AP with TEA 250 PPM & | 22.4 | 16.8 | 12 | 7.9 | 1.3 |
| Cu 0.5 PPM | | | | | |
| AP with TEA 125 PPM & | 22.4 | 16 | 12.2 | 8.1 | 1.3 |
| Cu 0.25 PPM | | | | | |

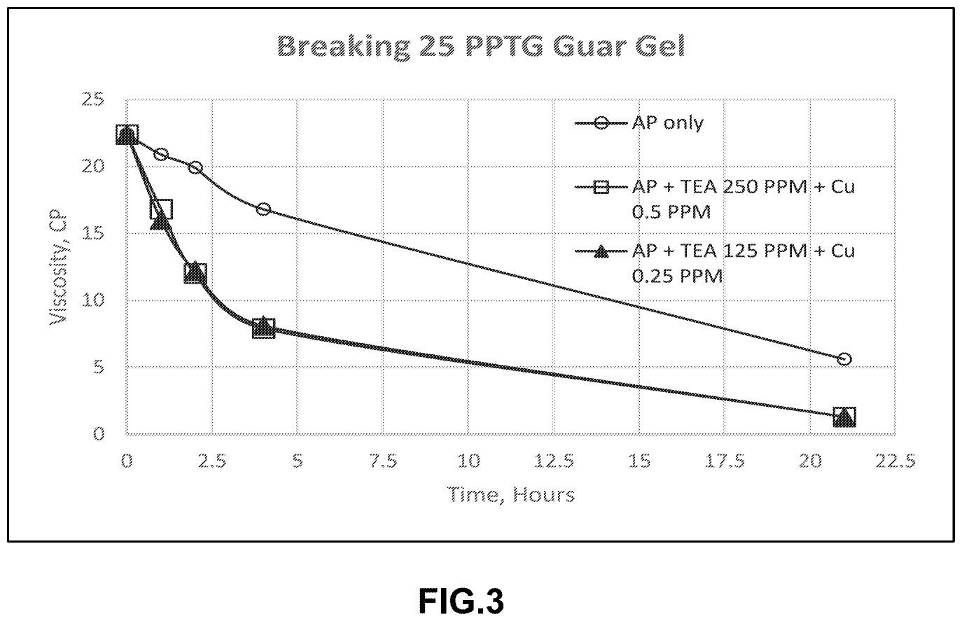

Turning now to Table 3 and FIG. 3, the first and second examples are compared. It is apparent from the data that there is a synergistic effect from the combination of TEA and Cu. Even at lower dosages of TEA and Cu, i.e., half the dosage, the gel break was far superior to using only AP, AP with TEA alone, or AP with Cu alone. The smallest dosage of the synergistic breaker also provides better performance than either of the individual components or mixture of any two of the components further showing the synergistic effect.

Furthermore, although AP is used in these examples, it can be expected that any oxidizer in combination with TEA and Cu would be considered a good synergistic breaker for polyacrylamide based and guar based slickwater systems when evaluated at temperatures between 100° F. and about 300° F., including but not limited to chlorites, chlorates, bromates, peroxides, persulfates, and perborates.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

1. A method for breaking a gelled fracturing fluid comprising:
blending an aqueous breaker composition of an oxidizer, a transition metal, and an alkali compound to a concentration of between 100 ppm and 150,000 ppm; and
adding the blended composition to a to a fracturing fluid including a polymer viscosifier, where the effective concentration of the blended composition is sufficient to reduce a viscosity of the fracturing fluid to a desired low value at downhole conditions within a time period coincident with a formation stimulation time period.

2. The method of claim 1, wherein the time period is between about 30 minutes and 240 minutes.

3. The method of claim 1, wherein the effective concentration of the aqueous breaker composition comprises between about 50 ppm and 100,000 ppm of the oxidizer, wherein the oxidizer comprises chlorites, chlorates, bromates, peroxides, persulfates, perborates, and mixtures or combinations thereof.

4. The method of claim 3, wherein the oxidizer is ammonium persulfate.

5. The method of claim 1, wherein the effective concentration of the aqueous breaker composition comprises between 0.1 ppm and 500 ppm of the transition metal, wherein the transition metal comprises a salt from the group consisting of cuprous chloride, cupric chloride, ferrous chloride, ferric chloride, cobalt chlorides, manganese chlorides, and chromium chlorides.

6. The method of claim 5, wherein the transition metal source is cupric chloride.

7. The method of claim 1, wherein the effective concentration of the aqueous breaker composition comprises between 50 ppm and 100,000 ppm of alkali compound, wherein the alkali comprises a hydroxide, carbonate or bicarbonate of ammonia, sodium, potassium, magnesium, lithium, amines, amino alcohols, or hydroxylamines.

8. The method of claim 7, wherein the alkali compound is triethanolamine.
